(19) United States
(12) Patent Application Publication
(10) Pub. No.: US 2022/0181724 A1
(43) Pub. Date: Jun. 9, 2022

(54) Batteries and Related Systems and Methods

(71) Applicant: ENERSYS DELAWARE INC., Reading, PA (US)

(72) Inventors: Ryan Scheidt, Warrensburg, MO (US); Matthew Runyan, Higginsville, MO (US); Donald L. Ridlen, Jr., Holden, MO (US); Weston Brantner, Warrensburg, MO (US); Jason Wilborn, Warrensburg, MO (US)

(21) Appl. No.: 17/600,779

(22) PCT Filed: Apr. 1, 2020
(86) PCT No.: PCT/US2020/026118

§ 371 Date: Oct. 1, 2021

Related U.S. Application Data
(60) Provisional application No. 62/828,659, filed on Apr. 3, 2019.
(60) Provisional application No. 62/970,291, filed on Feb. 5, 2020.

(51) Int. Cl. H01M 50/103; H01M 50/552; H01M 50/209

(52) U.S. Cl. CPC H01M 50/103; H01M 2220/20; H01M 50/209; H01M 50/561

(57) ABSTRACT

A battery includes: a case including a bottom wall, a front wall, aback wall, a left side wall, and a right side wall opposite the left side wall; a lid on the case opposite the bottom wall; at least one first elongated rib on the left side wall and extending outwardly away from the left side wall a first distance; and at least one second elongated rib on the right side wall and extending outwardly away from the right side wall a second distance that is the same as the first distance.

This application claims priority from U.S. Provisional Application No. 62/828,659, filed Apr. 3, 2019, and from U.S. Provisional Application No. 62/970,291, filed Feb. 5, 2020, the disclosure of each of which is incorporated by reference in its entirety.

### BACKGROUND

In certain situations, multiple interconnected batteries are held in a cabinet, rack, or tray. The batteries are tightly packed in the tray which can cause thermal management issues.

The batteries may be relatively heavy industrial batteries such as forklift batteries or industrial motive power batteries. It is desirable to be able to reliably and safely lower the batteries into the tray and lift the batteries from the tray.

Finally, it is desirable to have a robust seal for the internals of the battery (e.g., at the battery terminals).

### SUMMARY

Some embodiments of the present invention are directed to a battery including: a case including a bottom wall, a front wall, a back wall, a left side wall, and a right side wall opposite the left side wall; a lid on the case opposite the bottom wall; at least one first elongated rib on the left side wall and extending outwardly away from the left side wall a first distance; and at least one second elongated rib on the right side wall and extending outwardly away from the right side wall a second distance that is the same as the first distance.

In some embodiments, the first distance and second distance are each between 0.125 inches and 0.250 inches.

In some embodiments, the battery further includes: at least one left foot on the back wall adjacent the left side wall and extending outwardly away from the back wall a third distance; and at least one right foot on the back wall adjacent the right side wall and extending outwardly away from the back wall the third distance. The third distance may be between 0.125 inches and 0.750 inches. The at least one left foot may extend outwardly away from the left side wall the first distance. The at least one right foot may extend outwardly away from the right side wall the second distance. The at least one left foot may include first and second spaced apart left feet adjacent the left side wall. The at least one right foot may include first and second spaced apart right feet adjacent the right side wall.

In some embodiments, the battery further includes: a first left standoff on the left sidewall adjacent the front wall and extending outwardly away from the left side wall the first distance; a second left standoff on the left sidewall adjacent the front wall and extending outwardly away from the left sidewall the first distance; a first right standoff on the right sidewall adjacent the front wall and extending outwardly away from the right side wall the second distance; and/or second right standoff on the right sidewall adjacent the front wall and extending outwardly away from the right sidewall the second distance. In some embodiments: the first left standoff and the first left foot are equally spaced apart from the bottom wall; the second left standoff and the second left foot are equally spaced apart from the lid; the first right standoff and the first right foot are equally spaced apart from the bottom wall; and/or the second right standoff and the second right foot are equally spaced apart from the lid.

In some embodiments, the at least one first rib is equally spaced apart from each of the bottom wall and the lid; and/or the at least one second rib is equally spaced apart from each of the bottom wall and the lid. The at least one first rib may include first and second spaced apart left ribs. The at least one second rib may include first and second spaced apart right ribs.

In some embodiments, the battery further includes a belt loop member on the front wall and defining a channel that is configured to receive a lifting strap therethrough for lifting the battery. The belt loop member may be on a central portion of the front wall and may be aligned with the battery center of gravity.

In some embodiments, the battery further includes first and second terminals at the front wall. Each of the first and second terminals may include a bushing that is over-molded into the case and a post connected to the bushing. The post may be received through a mating hole in bussing that is connected to tabs of battery plates. The post and the bussing may be fused together by plasma welding to provide a hermetic seal between the internal and external components of the battery.

Some other embodiments of the present invention are directed to a battery system including: a tray having a back wall, a top wall, a bottom wall, a left wall, and a right wall; and a plurality of batteries in the tray. Each of the batteries includes: a casing including a bottom wall, a back wall, a front wall, a left side wall, and a right side wall; a lid on the casing opposite the bottom wall; at least left rib on the left side wall and extending outwardly away from the left side wall a first distance; and at least one right rib on the right side wall and extending outwardly away from the right side wall a second distance that is equal to the first distance. The batteries are received in the tray such that the left rib of one of the batteries abuts the right rib of an adjacent other one of the batteries such that an airflow gap is defined between the adjacent batteries. The batteries are received in the tray such that, for each battery that is adjacent the left wall of the tray, the right rib of the battery abuts the left wall of the tray such that an airflow gap is defined between the battery and the left wall of the tray. The batteries are received in the tray such that, for each battery that is adjacent the right wall of the tray, the left rib of the battery abuts the right wall of the tray such that an airflow gap is defined between the battery and the right wall of the tray.

In some embodiments: each battery includes a plurality of feet on the bottom wall and extending outwardly from the bottom wall; the batteries are received in the tray such that the feet of one of the batteries are received on the lid of an adjacent other one of the batteries such that an airflow gap is defined between the adjacent batteries; and/or the batteries are received in the tray such that, for each battery that is adjacent the bottom wall of the tray, the feet of the battery is are received on the bottom wall of the tray such that an airflow gap is defined between the battery and the bottom wall of the tray.

In some embodiments: each battery includes first and second spaced apart left feet adjacent the left side wall and extending outwardly away from the left side wall the first distance; each battery includes first and second spaced apart right feet adjacent the right side wall and extending outwardly away from the right side wall the second distance; each battery includes first and second left standoffs on the left sidewall adjacent the front wall and extending outwardly away from the left side wall the first distance; and/or each battery includes first and second right standoffs on the right sidewall adjacent the front wall and extending outwardly away from the right sidewall the second distance. The batteries may be received in the tray such that the first and second left standoffs of one of the batteries abuts the first and second right standoffs of an adjacent other one of the batteries. The batteries may be received in the tray such that, for each battery that is adjacent the left wall of the tray, the first and second right feet and the first and second right standoffs of the battery abut the left wall of the tray. The batteries may be received in the tray such that, for each battery that is adjacent the right wall of the tray, the first and second left feet and the first and second left standoffs of the battery abuts the right wall of the tray.

In some embodiments, the batteries are received in the tray with the front wall of each battery facing outward of the tray. Each battery may include a belt loop member on a central portion of the front wall and defining a channel that is configured to receive a belt for lowering the battery into the tray and/or lifting the battery into the tray.

Some other embodiments of the present invention are directed to a method including: providing a battery comprising a case and first and second terminals, each terminal including a bushing over-molded into the case and a busbar extending upwardly from the bushing; and for each terminal, plasma welding the busbar of the terminal including melting a top portion of the busbar such that the busbar is fused to a bussing that is connected to plate tabs of the battery.

In some embodiments, the method further includes, for each terminal: receiving the busbar of the terminal in a first opening of a connector; and receiving a busbar of the bussing in a second opening of the connector.

In some embodiments, the connector includes a base between the first opening and the second opening. The method may further include, for each terminal: plasma welding the busbar of the bussing including melting a top portion of the busbar; flowing molten metal onto the base in response to plasma welding the busbar of the terminal and plasma welding the busbar of the bussing; and allowing the molten metal to harden to thereby fuse the busbar of the terminal and the busbar of the bussing. A void may be defined above the base and between the busbar of the terminal and the busbar of the bussing, and the molten metal may fill the void.

In some embodiments, the connector includes at least one sidewall that extends upwardly from the first and second openings and/or the base, and the busbar of the terminal and the busbar of the bussing are surrounded by the at least one sidewall. The method may further include retaining the molten metal in the connector using the at least one sidewall.

In some embodiments, the busbar of the terminal and the busbar of the bussing are each spaced apart from the at least one sidewall. The method may further include flowing the molten metal between the busbar of the terminal and the at least one sidewall and flowing the molten metal between the busbar of the bussing and the at least one sidewall in response to plasma welding the busbar of the terminal and plasma welding the busbar of the bussing.

In some embodiments: the busbar of the terminal and/or the busbar of the bussing extend above an uppermost surface of the case of the battery prior to the plasma welding the busbar of the terminal and/or the plasma welding the busbar of the bussing; and the busbar of the terminal and/or the busbar of the bussing are below the uppermost surface of the case of the battery after the plasma welding the busbar of the terminal and/or the plasma welding the busbar of the bussing.

In some embodiments, the method further includes installing a cover around and/or on the uppermost surface of the case of the battery after the plasma welding the busbar of the terminal and/or the plasma welding the busbar of the bussing.

In some embodiments, the method further includes, for each terminal, receiving the busbar of the terminal in a mating opening of a bussing that is connected to plate tabs of the battery. The bussing may include a raised portion surrounding the mating opening, the raised portion configured to retain molten metal that flows in response to plasma welding the busbar of the terminal.

Some other embodiments of the present invention are directed to a method including: providing a battery including a case and a plurality of terminals, each terminal including a bushing over-molded into the case and a post extending upwardly from the bushing; receiving the post in a mating opening of a bussing that is connected to plate tabs of the battery; and plasma welding the post to the bussing including melting a top portion of the post such that a perimeter of the post is fused to the bussing.

Some other embodiments of the present invention are directed to a battery including: a case; a first set of plates in the case with a tab extending from each of the plates; a second set of plates in the case with a tab extending from each of the plates; a first bussing connected to the tabs of the first set of plates; a second bussing connected to the tabs of the second set of plates; first and second terminals, each terminal comprising a bushing over-molded into the case and a busbar extending upwardly from the bushing; and a connector for each of the first and second terminals, the connector including first and second openings with the busbar of the terminal extending through the first opening and a busbar of the bussing extending through the second opening. The connector is configured to receive molten metal after top portions of the busbar of the terminal and the busbar of the bussing have been plasma welded to thereby fuse the busbar of the terminal and the busbar of the bussing together.

In some embodiments, the connector includes a base between the first opening and the second opening, a void is defined above the base and between the busbar of the terminal and the busbar of the bussing, and the molten metal flows onto the base and fills the void after the top portions of the busbar of the terminal and the busbar of the bussing have been plasma welded.

In some embodiments, the connector includes at least one sidewall that extends upwardly from the first and second openings and/or the base, and the busbar of the terminal and the busbar of the bussing are surrounded by the at least one sidewall. The at least one sidewall may include first, second, third, and fourth sidewalls. The first opening may be defined by the first sidewall, the third sidewall, the fourth sidewall, and the base. The second opening may be defined by the second sidewall, the third sidewall, the fourth sidewall, and the base. The base may extend between the third and fourth sidewalls.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a front perspective view of a battery according to some embodiments of the present invention.

FIG. 2 is a rear perspective view of the battery of FIG. 1.

FIG. 3 is a rear view of the battery of FIG. 1.

FIG. 4 is a side view of the battery of FIG. 1.

FIG. 5 is an opposite side view of the battery of FIG. 1.

FIG. 6 is a front view of the battery of FIG. 1.

FIG. 7 is a perspective view of a plurality of batteries of FIG. 1 held in a tray.

FIG. 8 is a fragmentary perspective view of the battery of FIG. 1 illustrating the battery terminals according to some embodiments of the present invention.

FIG. 9 is a front perspective view of a battery according to some other embodiments of the present invention.

FIG. 10 is a fragmentary perspective sectional view of the battery of FIG. 9 illustrating a battery terminal and associated components prior to a plasma welding process according to some embodiments of the present invention.

FIG. 11 is a fragmentary perspective sectional view of the battery of FIG. 9 illustrating the battery terminal and associated components after a plasma welding process according to some embodiments of the present invention.

FIG. 12 is a perspective view of a connector of FIG. 10.

FIG. 13 is a fragmentary top view of the battery of FIG. 9.

FIG. 14A is a side sectional view of the battery of FIG. 9 illustrating features associated with the terminal prior to a plasma welding process being performed thereon.

FIG. 14B is a side sectional view of the battery of FIG. 9 illustrating features associated with the terminal after the plasma welding process being performed thereon.

FIG. 15 is a fragmentary perspective sectional view of the battery of FIG. 9 illustrating a battery terminal configuration according to some embodiments of the present invention.

### DETAILED DESCRIPTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “includes,” “comprising,” and/or “including,” when used in this specification, specify the presence of stated features, integers, steps, operations, elements, and/or components, but do not preclude the presence or addition of one or more other features, integers, steps, operations, elements, components, and/or groups thereof.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

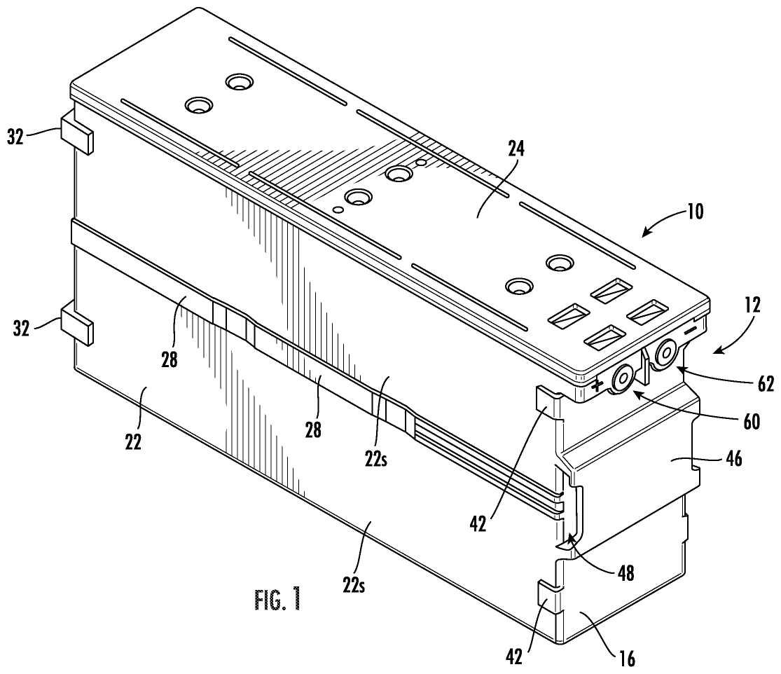

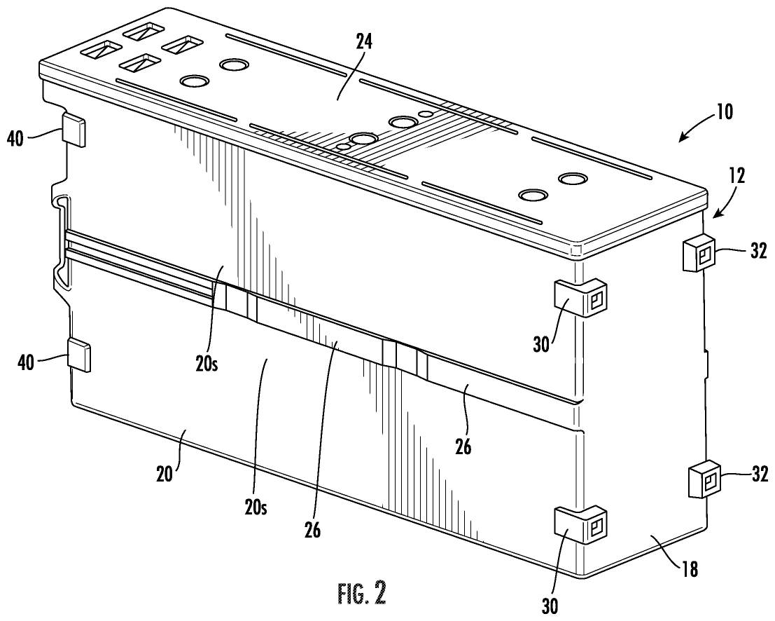

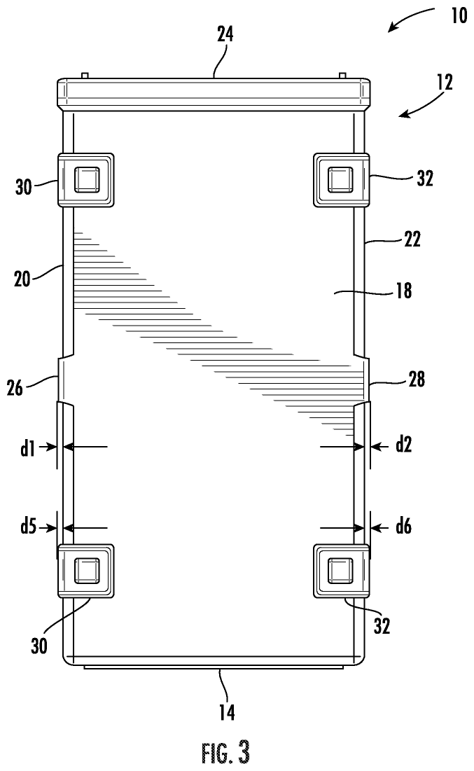

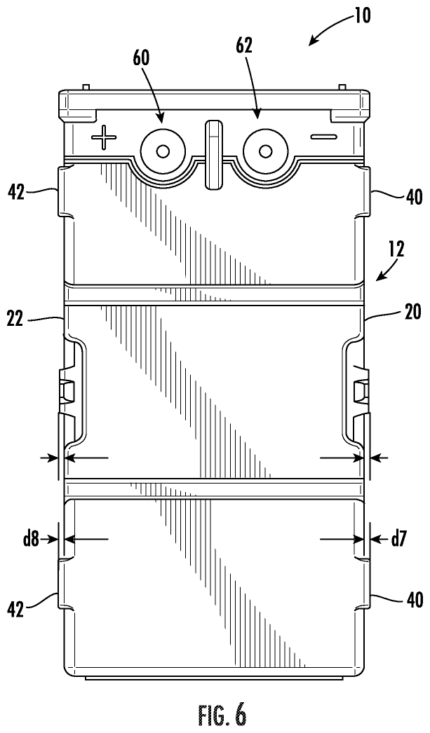

A battery 10 according to some embodiments is shown in FIGS. 1-6. The battery 10 includes a case 12 including a bottom wall 14, a front wall 16, a back or rear wall 18 opposite the front wall 16, a left (side) wall 20, and a right (side) wall 22 opposite the left (side) wall 20. A lid 24 is on the case 12 opposite the bottom wall 14.

At least one left elongated rib 26 is on the left wall 20. As illustrated, two spaced apart left ribs 26 are on the left wall 20, although it will be appreciated that only one left rib or more than two left ribs can be provided. Each left rib 26 extends outwardly away from the left wall 20 a first distance d1. In other words, each left rib 26 extends or protrudes perpendicularly from a planar surface 20s of the left wall 20 the first distance d1. Each left rib 26 may be integrally formed with the case 12 and/or the left wall 20.

Similarly, at least one right elongated rib 28 is on the right wall 22. As illustrated, two spaced apart right ribs 28 are on the right wall 22, although it will be appreciated that only one right rib or more than two right ribs can be provided. Each right rib 28 extends outwardly away from the right wall 22 a second distance d2. In other words, each right rib 28 extends or protrudes perpendicularly from a planar surface 22s of the right wall 22 the second distance d2. Each right rib 28 may be integrally formed with the case 12 and/or the right wall 22.

The first distance d1 and the second distance d2 may be equal to one another. In some embodiments, the first distance d1 and the second distance d2 are each 0.125 inches, about 0.125 inches, or between 0.125 inches and 0.250 inches.

As will be described in more detail below, the ribs 26, 28 provide an airflow gap between adjacent batteries and/or between a battery and a wall of a tray (e.g., when an array of batteries are arranged in the tray). In addition, the ribs 26, 28 provide sidewall strength to resist case bulge.

At least one left foot 30 is on the back wall 18 adjacent the left wall 20. As illustrated, two spaced apart left feet 30 are on the back wall 18, although it will be appreciated that only one (elongated) left foot or more than two left feet can be provided. Each left foot 30 extends outwardly (e.g., perpendicularly) away from the back wall 18 a third distance d3. Each left foot 30 may be integrally formed with the case 12 and/or the back wall 18.

Similarly, at least one right foot 32 is on the back wall 18 adjacent the right wall 22. As illustrated, two spaced apart right feet 32 are on the back wall 18, although it will be appreciated that only one (elongated) right foot or more than two right feet can be provided. Each right foot 32 extends outwardly (e.g., perpendicularly) away from the back wall 18 a fourth distance d4. Each right foot 32 may be integrally formed with the case 12 and/or the back wall 18.

The third distance d3 and the fourth distance d4 may be equal to one another. In some embodiments, the third distance d3 and the fourth distance d4 are each 0.50 inches, about 0.50 inches, or between 0.125 inches and 1 inch.

Each left foot 30 may also extend outwardly (e.g., perpendicularly) away from the left wall 20 a fifth distance d5. The fifth distance d5 may be equal to the first distance d1 of the left rib 26. In some embodiments, the first distance d1 and the fifth distance d5 are each 0.125 inches, about 0.125 inches, or between 0.125 inches and 0.250 inches.

Each right foot 32 may also extend outwardly (e.g., perpendicularly) away from the right wall 22 a sixth distance d6. The sixth distance d6 may be equal to the second distance d2 of the right rib 28. In some embodiments, the second distance d2 and the sixth distance d6 are each 0.125 inches, about 0.125 inches, or between 0.125 inches and 0.250 inches.

As will be described in more detail below, the feet 30, 32 provide an airflow gap between adjacent batteries and/or between a battery and a wall of a tray (e.g., when an array of batteries are arranged in the tray).

At least one left standoff 40 may be on the left wall 20 adjacent the front wall 16. As illustrated, two spaced apart left standoffs 40 are on the left wall 20, although it will be appreciated that only one (elongated) left standoff or more than two left standoffs can be provided. Each left standoff 40 may be integrally formed with the case 12 and/or the left wall 20. Each left standoff 40 extends outwardly (e.g., perpendicularly) away from the left wall 20 a seventh distance d7. The seventh distance d7 may be equal to the first distance d1 of the left rib 26 and/or the fifth distance d5 of the left foot 30. In some embodiments, the first distance d1, the fifth distance d5, and the seventh distance d7 are each 0.125 inches, about 0.125 inches, or between 0.125 inches and 0.250 inches.

Similarly, at least one right standoff 42 may be on the right wall 22 adjacent the front wall 16. As illustrated, two spaced apart right standoffs 42 are on the right wall 22, although it will be appreciated that only one (elongated) right standoff or more than two right standoffs can be provided. Each right standoff 42 may be integrally formed with the case 12 and/or the right wall 22. Each right standoff 42 extends outwardly (e.g., perpendicularly) away from the right wall 22 an eighth distance d8. The eighth distance d8 may be equal to the second distance d2 of the right rib 28 and/or the sixth distance d6 of the right foot 32. In some embodiments, the second distance d2, the sixth distance d6, and the eighth distance d8 are each 0.125 inches, about 0.125 inches, or between 0.125 inches and 0.250 inches.

As will be described in more detail below, the feet 30, 32 and/or the standoffs 40, 42 may cooperate with the ribs 26, 28 to provide an airflow gap between adjacent batteries and/or between a battery and a wall of a tray (e.g., when an array of batteries are arranged in the tray).

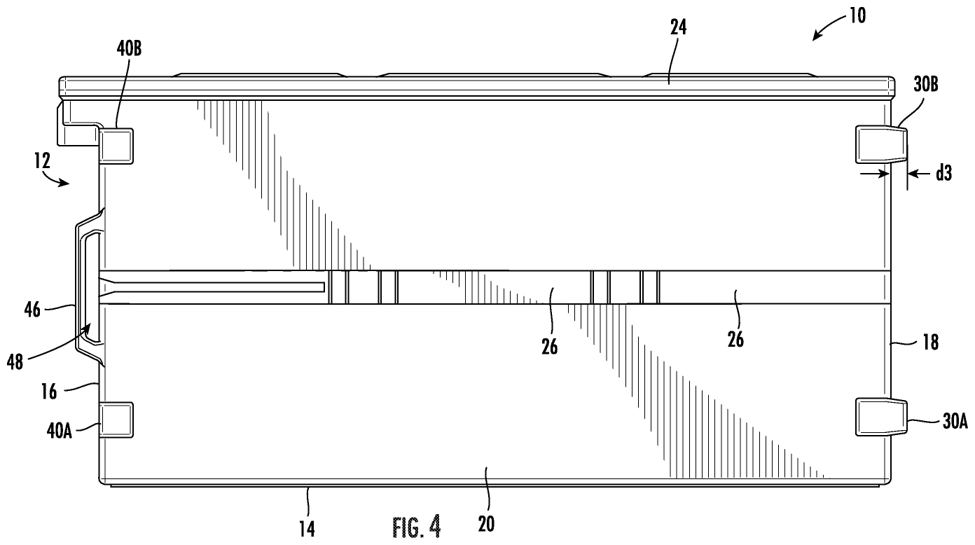

Referring to FIG. 4, each left rib 26 may be equally spaced apart from each of the bottom wall 14 and the lid 24. A first one 40A of the left standoffs 40 and a first one 30A of the left feet 30 may be equally spaced apart from the bottom wall 14. A second one 40B of the left standoffs 40 and a second one 30B of the left feet 30 may be equally spaced apart from the lid 24. In this way, the foot 30A and the standoff 40A are aligned in a longitudinal direction (from the front wall 16 to the back wall 18) and the foot 30B and the standoff 40B are aligned in a longitudinal direction (from the front wall 16 to the back wall 18).

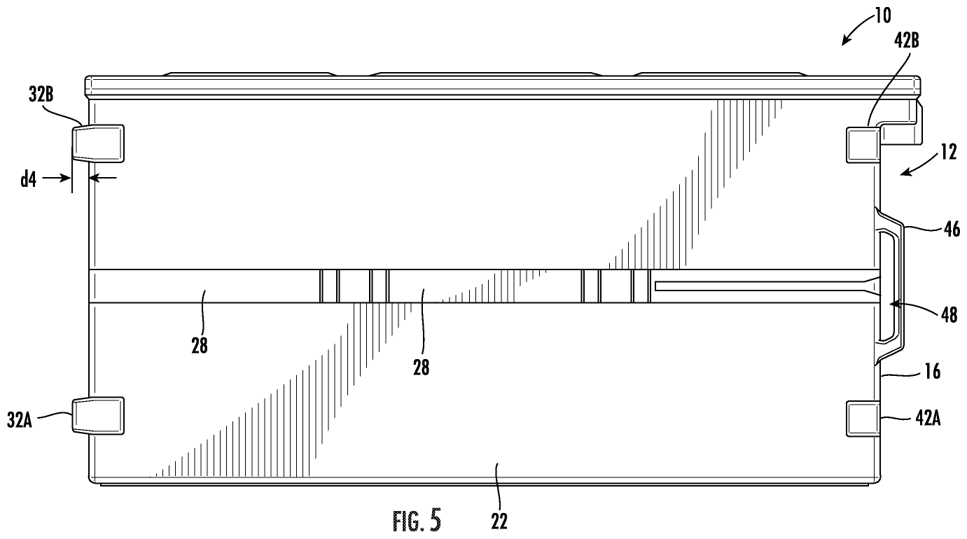

Referring to FIG. 5, each right rib 28 may be equally spaced apart from each of the bottom wall 14 and the lid 24. A first one 42A of the right standoffs 42 and a first one 32A of the right feet 30 may be equally spaced apart from the bottom wall 14. A second one 42B of the right standoffs 42 and a second one 32B of the right feet 40 may be equally spaced apart from the lid 24. In this way, the foot 32A and the standoff 42A are aligned in a longitudinal direction (from the front wall 16 to the back wall 18) and the foot 32B and the standoff 42B are aligned in a longitudinal direction (from the front wall 16 to the back wall 18).

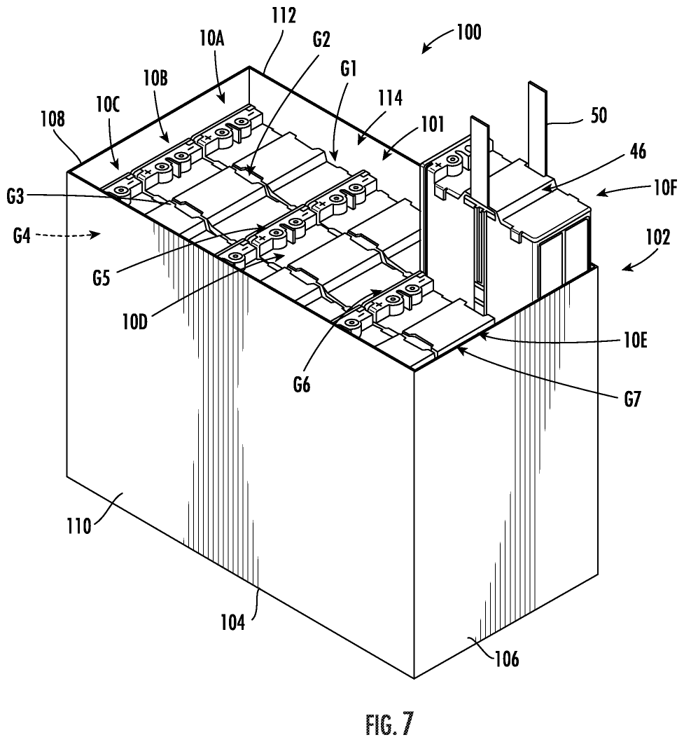

Referring to FIGS. 1, 4, and 5, a belt loop member 46 may be on the front wall 16. The belt loop member 46 defines a channel 48 that is configured to receive a belt or lifting strap 50 therethrough (FIG. 7). The belt loop member 46 may be integrally formed with the case 12 and/or the front wall 16. Also on the front wall 16 are first and second terminals 60, 62. The terminals 60, 62 are described in more detail below.

FIG. 7 illustrates a battery system 100 including a cabinet, rack, or tray 102 and a plurality of the batteries 10 as described herein (also referred to herein as an array 101 of the batteries 10). The battery system 100 may be used to power an industrial vehicle such as a forklift.

The tray 102 includes a back wall 104. Extending upwardly away from the back wall 104 are a bottom wall 106, a top wall 108, a left (side) wall 110, and a right (side) wall 112. The bottom wall 106, the top wall 108, the left wall 110, and the right wall 112 define an opening 114 through which the batteries 10 may be placed in and removed from the tray 102.

The batteries as described herein include several features that provide airflow gaps and may enhance thermal management of the array of batteries held in the tray. For example, referring to FIGS. 1-7, the left ribs 26, the left feet 30, and/or the left standoffs 40 of the battery 10A are adjacent and/or abut the right wall 112 of the tray 102 such that a first airflow gap G1 is defined between the left wall 20 of the battery 10A and the right wall 112 of the tray 102. In some embodiments, the gap G1 has a width of 0.125 inches or about 0.125 inches (corresponding to the distance the left ribs 26, the left feet 30, and/or the left standoffs 40 extend away from the left wall 20).

The right ribs 28, the right feet 32, and/or the right standoffs 42 of the battery 10A are adjacent and/or abut the left ribs 26, the left feet 30, and/or the left standoffs 40, respectively, of the battery 10B such that a second airflow gap G2 is defined between the right wall 22 of the battery 10A and the left wall 20 of the battery 10A.

The right ribs 28, the right feet 32, and/or the right standoffs 42 of the battery 10B are adjacent and/or abut the left ribs 26, the left feet 30, and/or the left standoffs 40, respectively, of the battery 10C such that a second airflow gap G3 is defined between the right wall 22 of the battery 10B and the left wall 20 of the battery 10C.

In some embodiments, the gap G2 has a width of 0.25 inches or about 0.25 inches (corresponding to the distance the right ribs 28, the right feet 32, and/or the right standoffs 42 extend away from the right wall 22 of the battery 10A combined with the distance the left ribs 26, the left feet 30, and/or the left standoffs 40 extend away from the left wall 20 of the battery 10B). In some embodiments, the gap G3 has a width of 0.25 inches or about 0.25 inches (corresponding to the distance the right ribs 28, the right feet 32, and/or the right standoffs 42 extend away from the right wall 22 of the battery 10B combined with the distance the left ribs 26, the left feet 30, and/or the left standoffs 40 extend away from the left wall 20 of the battery 10C).

The right ribs 28, the right feet 32, and/or the right standoffs 42 of the battery 10C are adjacent and/or abut the left wall 110 of the tray 102 such that a fourth airflow gap G4 is defined between the right wall 22 of the battery 10C and the left wall 110 of the tray 102. In some embodiments, the gap G4 has a width of 0.125 inches or about 0.125 inches (corresponding to the distance the right ribs 28, the right feet 32, and/or the right standoffs 42 extend away from the right wall 22 of the battery 10C).

The feet 30, 32 of the battery 10B are adjacent and/or abut the lid 24 of the battery 10D such that a fifth airflow gap G5 is defined between the bottom wall 14 of the battery 10B and the lid 24 of the battery 10D. The feet 30, 32 of the battery 10D are adjacent and/or abut the lid 24 of the battery 10E such that a sixth airflow gap G6 is defined between the bottom wall 14 of the battery 10D and the lid 24 of the battery 10E. The feet 30, 32 of the battery 10E are adjacent and/or abut the bottom wall 106 of the tray 102 such that a seventh airflow gap G7 is defined between the bottom wall 14 of the battery 10E and the bottom wall 106 of the tray 102.

In some embodiments, each of the airflow gaps G5, G6, and G7 have a width corresponding to the height of the feet 30, 32 of the batteries 10 (e.g., about 0.5 inches or range of 0.125 inches to 0.75 inches).

It will be appreciated that additional airflow gaps are defined between further adjacent ones of the batteries as well as between further batteries in the array and the walls 110, 112 of the tray 102.

Referring to FIGS. 1 and 7, the belt loop member 46 and the belt loop channel 48 are configured to receive a belt 50 therethrough. The belt 50 may be connected to a lifting and lowering apparatus such as a hoist to allow the battery 10F to be selectively lifted from the tray 102 and lowered into the tray 102.

As described above, the battery 10F may be an industrial battery such as used for a forklift. Such a battery may be heavy. Referring to FIG. 5, the belt loop member 46 may be centrally located on the front wall 16. In some embodiments, the belt loop member is equally spaced apart from each of the bottom wall 14 and the lid 24. This allows the battery to be stably lifted from and lowered into the tray 102.

Some known batteries are lifted and lowered using the terminals. However, the terminals may not be positioned over the center of gravity of the battery. Further, the terminals may break when lifting or lowering the battery.

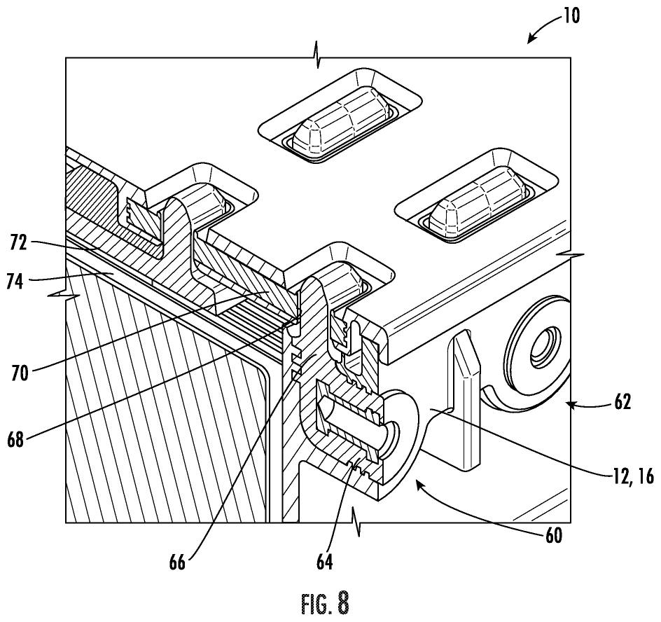

FIG. 8 illustrates the terminals 60, 62 in more detail. Although the terminal 60 will be primarily described, it will be understood that the terminal 62 may have the same or substantially the same configuration.

The terminal 60 includes a bushing 64 that is over-molded into the battery case 12 (e.g., the front wall 16). A busbar 66 or post extends upwardly from the bushing 64 and is received through a mating opening 68 in a bussing 70 that is connected to tabs 72 of battery plates 74. The perimeter of the busbar 66 and the bussing 70 are fused together by plasma welding. Specifically, the top portion of the busbar 66 is melted so metal flows into the area to be fused together.

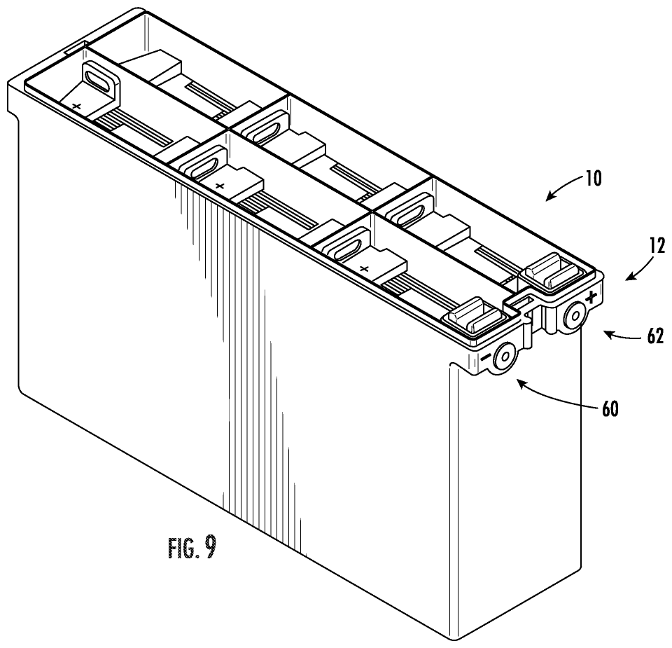

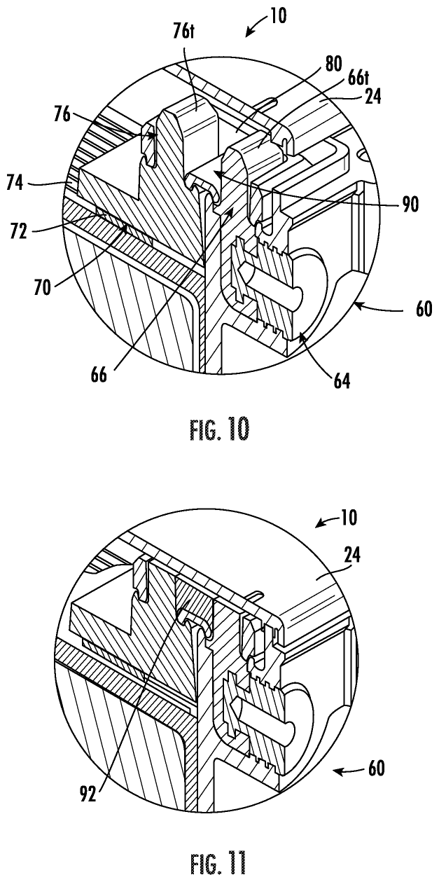

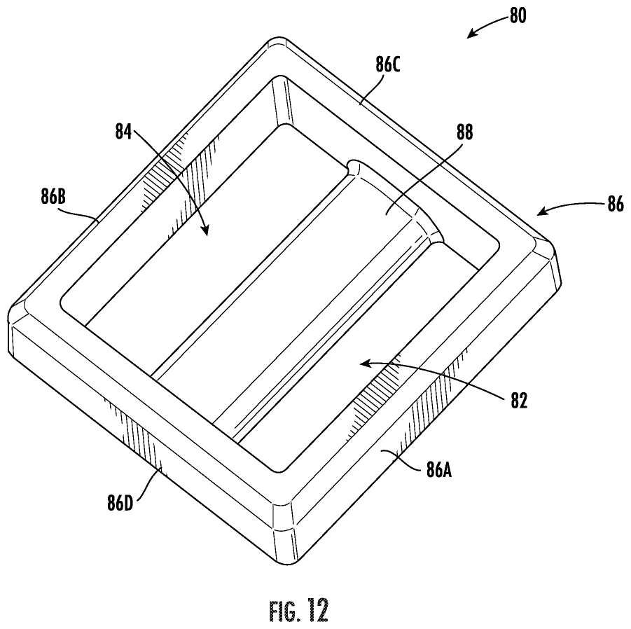

The battery 10 according to some other embodiments is illustrated in FIG. 9. The battery is shown without the cover (the cover 24 is shown in FIGS. 10 and 11).

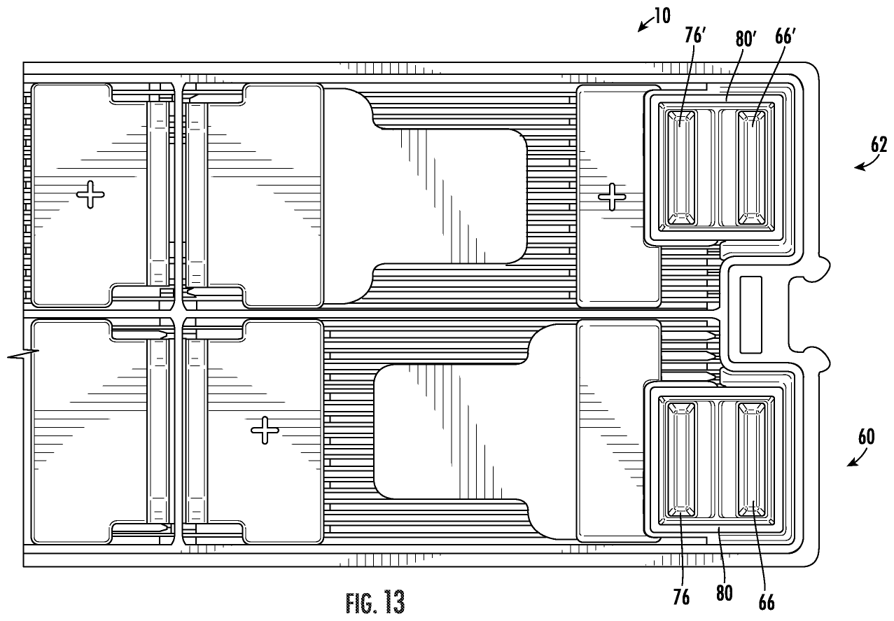

Referring to FIG. 10, the terminal 60 includes the bushing 64. The bushing 64 may be formed of brass. The busbar or post 66 extends upwardly from the bushing 64 and is received through a first opening 82 of a connector 80 (FIG. 12). The busbar 66 may be formed of lead. The bushing 64 and the busbar 66 may be encapsulated or overmolded in the battery case 12.

The bussing 70 is connected to the tabs 72 of the battery plates 74. A busbar 76 extends upwardly from the bussing 70 and is received through a second opening 84 of the connector 80 (FIG. 12). The bussing 70 and the busbar 76 may be formed of lead.

The connector 80 is illustrated in FIG. 12. The connector 80 includes an outer or perimeter wall 86. The outer wall 86 includes first and second opposed sidewalls 86A, 86B and third and fourth opposed sidewalls 86C, 86D. The connector 80 includes a base 88 that extends between the third and fourth sidewalls 86C, 86D.

The first opening 82 is between the first sidewall 86A and the base 88. Specifically, the first opening 82 is defined by the first sidewall 86A, the third sidewall 86C, the fourth sidewall 86D, and the base 88. The second opening 84 is between the second sidewall 86B and the base 88. Specifically, the second opening 84 is defined by the second sidewall 86B, the third sidewall 86C, the fourth sidewall 86D, and the base 88. The connector 80 may be formed of lead.

Referring again to FIG. 10, a gap or void 90 is defined between the busbar 66 and the busbar 76.

Referring to FIGS. 10 and 11, a top portion 66t of the busbar 66 and a top portion 76t of the busbar are melted by plasma welding so that metal flows into the void 90. The busbar 66 and the busbar 76 are thereby fused together. The molten metal hardens to form a metal (e.g., lead) interface 92 for a robust connection between the busbars 66, 76.

The connector 80 including the perimeter wall 86 helps to contain the molten metal in the void 90 during the plasma welding process. Each of the busbars 66, 76 may be spaced apart from the perimeter wall 86 such that molten metal also flows between each of the busbars 66, 76 and the perimeter wall 86.

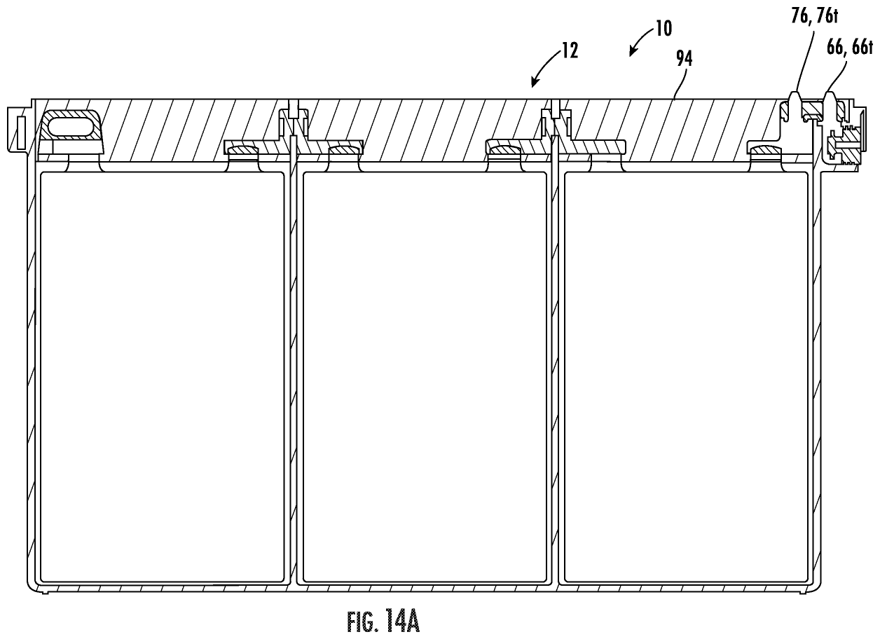

It will be appreciated that the second terminal 62 has the same or substantially the same configuration as the first terminal 60. For example, referring to FIG. 13, the busbars 66′, 76′ are held in the connector 80′ and the same plasma welding process may be performed as described above with regard to the first terminal 60.

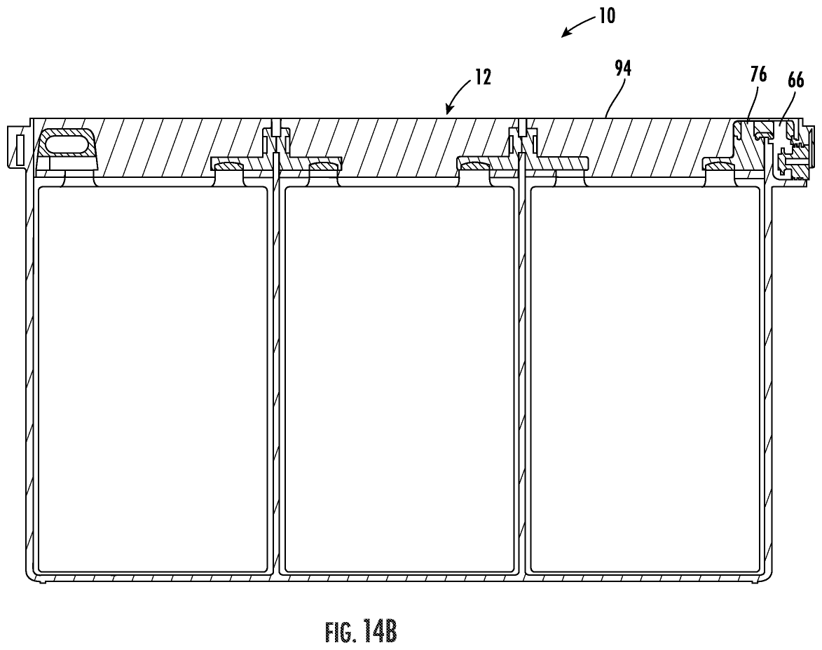

Referring to FIG. 14A, in some embodiments, the busbars 66, 76 including the top portions 66t, 76t thereof extend above an uppermost surface 94 of the battery case 12 before the plasma welding process. Referring to FIG. 14B, in some embodiments, the busbars 66, 76 are below the uppermost surface 94 of the battery case 12 after the plasma welding process.

Referring to FIG. 11, the battery cover 24 may be placed on the case 12 after the plasma welding process. The battery cover 24 may be installed on and/or around the uppermost surface 94 of the battery case 12 (FIGS. 14A and 14B).

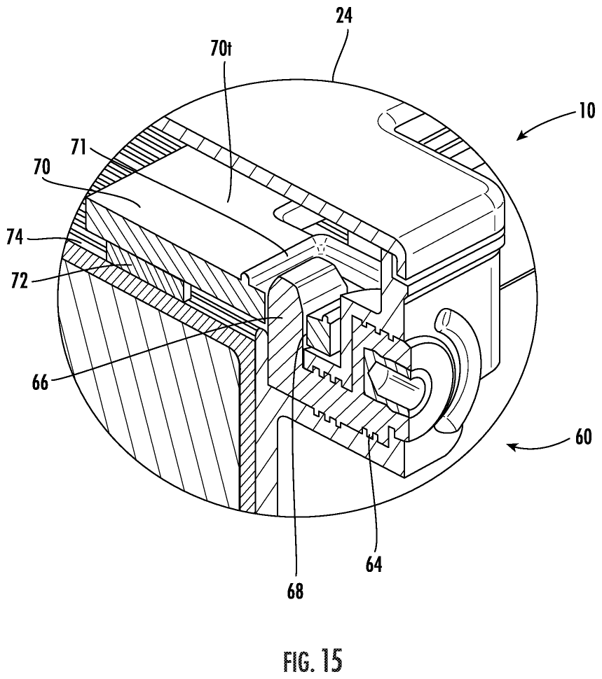

The terminal configuration according to some other embodiments is illustrated in FIG. 15. The terminal 60 includes the bushing 64 that is over-molded into the battery case 12. The busbar 66 or post extends upwardly from the bushing 64 and is received through the mating opening 68 in the bussing 70 that is connected to the tabs 72 of the battery plates 74. The perimeter of the busbar 66 and the bussing 70 are fused together by plasma welding. Specifically, the top portion of the busbar 66 is melted so metal flows into the area to be fused together (e.g., into and/or around the mating opening 68).

The bussing 70 may include a raised portion 71 (e.g., relative to a top surface 70t of the bussing 70) surrounding the mating opening 68 and/or the busbar 66. The raised portion 71 may act as a barrier or wall to prevent the spread of molten metal during the plasma welding process.

Therefore, the battery terminal is a molded conductive metal component with a threaded insert and used for the mechanical connection to the battery. The over-molded bushing includes an integrated busbar to create an electrical conductor between the internal cell packs and external connections. The terminal including the busbar is over-molded into the case of the battery to create a robust hermetically sealed electrical path from inside to outside the battery. The internal termination of the busbar is exposed to allow fusion to internal components. The exposed portion of the busbar is inserted into a mating hole or opening defined in the internal bussing of the battery or the connector. The interface between the over-molded bushing and the internal components are fused together to form a conductive path to the external consumer connection points.

Some known batteries do not use terminals directly connected to internal bussing via a metallurgical fusion connection. Some known batteries do not use over-molded terminals with integrated bussing through the battery container.

Some known batteries use resistance welding (including through the battery case and/or cover) which can provide a relatively weak connection and lead to failure. In contrast, the terminal configuration and the fusion welding process according to the present invention increases the size of the weld interface thereby improving the battery seal integrity and increasing performance.

The type of connection of the present invention requires less internal space than typical designs, which allows larger plates to be utilized. The larger plates will increase power densities over a typical battery of the same size.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

1. A battery comprising:
a case comprising a bottom wall, a front wall, a back wall, a left side wall, and a right side wall opposite the left side wall;
a lid on the case opposite the bottom wall;
at least one first elongated rib on the left side wall and extending outwardly away from the left side wall a first distance; and
at least one second elongated rib on the right side wall and extending outwardly away from the right side wall a second distance that is the same as the first distance.

2. The battery of claim 1 wherein the first distance and second distance are each between 0.125 inches and 0.250 inches.

3. The battery of claim 1 further comprising:
at least one left foot on the back wall adjacent the left side wall and extending outwardly away from the back wall a third distance; and
at least one right foot on the back wall adjacent the right side wall and extending outwardly away from the back wall the third distance.

4. The battery of claim 3 wherein the third distance is between 0.125 inches and 0.750 inches.

5. The battery of claim 3 wherein:
the at least one left foot extends outwardly away from the left side wall the first distance; and
the at least one right foot extends outwardly away from the right side wall the second distance.

6. The battery of claim 3 wherein:
the at least one left foot comprises first and second spaced apart left feet adjacent the left side wall; and
the at least one right foot comprises first and second spaced apart right feet adjacent the right side wall.

7. The battery of claim 6 further comprising:
a first left standoff on the left sidewall adjacent the front wall and extending outwardly away from the left side wall the first distance;
a second left standoff on the left sidewall adjacent the front wall and extending outwardly away from the left sidewall the first distance;
a first right standoff on the right sidewall adjacent the front wall and extending outwardly away from the right side wall the second distance; and
a second right standoff on the right sidewall adjacent the front wall and extending outwardly away from the right sidewall the second distance.

8. The battery of claim 7 wherein:
the first left standoff and the first left foot are equally spaced apart from the bottom wall;
the second left standoff and the second left foot are equally spaced apart from the lid;
the first right standoff and the first right foot are equally spaced apart from the bottom wall; and
the second right standoff and the second right foot are equally spaced apart from the lid.

9. The battery of claim 1 wherein:
the at least one first rib is equally spaced apart from each of the bottom wall and the lid; and
the at least one second rib is equally spaced apart from each of the bottom wall and the lid.

10. The battery of claim 9 wherein:
the at least one first rib comprises first and second spaced apart left ribs; and
the at least one second rib comprises first and second spaced apart right ribs.

11. The battery of claim 1 further comprising a belt loop member on the front wall and defining a channel that is configured to receive a lifting strap therethrough for lifting the battery.

12. The battery of claim 11 wherein the belt loop member is on a central portion of the front wall and is aligned with the battery center of gravity.

13. The battery of claim 1 further comprising first and second terminals at the front wall.

14. The battery of claim 13 wherein each of the first and second terminals comprises a bushing that is over-molded into the case and a post connected to the bushing.

15. The battery of claim 14 wherein:
the post is received through a mating hole in bussing that is connected to tabs of battery plates;
the post and the bussing are fused together by plasma welding to provide a hermetic seal between the internal and external components of the battery.

16. A battery system comprising:
a tray having a back wall, a top wall, a bottom wall, a left wall, and a right wall; and
a plurality of batteries in the tray;
wherein each of the batteries comprises:
a casing comprising a bottom wall, a back wall, a front wall, a left side wall, and a right side wall;
a lid on the casing opposite the bottom wall;
at least left rib on the left side wall and extending outwardly away from the left side wall a first distance; and
at least one right rib on the right side wall and extending outwardly away from the right side wall a second distance that is equal to the first distance;
wherein the batteries are received in the tray such that the left rib of one of the batteries abuts the right rib of an adjacent other one of the batteries such that an airflow gap is defined between the adjacent batteries;
wherein the batteries are received in the tray such that, for each battery that is adjacent the left wall of the tray, the right rib of the battery abuts the left wall of the tray such that an airflow gap is defined between the battery and the left wall of the tray; and
wherein the batteries are received in the tray such that, for each battery that is adjacent the right wall of the tray, the left rib of the battery abuts the right wall of the tray such that an airflow gap is defined between the battery and the right wall of the tray.

17. The system of claim 16 wherein:
each battery comprises a plurality of feet on the bottom wall and extending outwardly from the bottom wall;
the batteries are received in the tray such that the feet of one of the batteries are received on the lid of an adjacent other one of the batteries such that an airflow gap is defined between the adjacent batteries; and
wherein the batteries are received in the tray such that, for each battery that is adjacent the bottom wall of the tray, the feet of the battery is are received on the bottom wall of the tray such that an airflow gap is defined between the battery and the bottom wall of the tray.

18. The system of claim 16 wherein:
each battery comprises first and second spaced apart left feet adjacent the left side wall and extending outwardly away from the left side wall the first distance;
each battery comprises first and second spaced apart right feet adjacent the right side wall and extending outwardly away from the right side wall the second distance;
each battery comprises first and second left standoffs on the left sidewall adjacent the front wall and extending outwardly away from the left side wall the first distance;
each battery comprises first and second right standoffs on the right sidewall adjacent the front wall and extending outwardly away from the right sidewall the second distance;
the batteries are received in the tray such that the first and second left feet of one of the batteries abuts the first and second right feet of an adjacent other one of the batteries;
wherein the batteries are received in the tray such that the first and second left standoffs of one of the batteries abuts the first and second right standoffs of an adjacent other one of the batteries;
wherein the batteries are received in the tray such that, for each battery that is adjacent the left wall of the tray, the first and second right feet and the first and second right standoffs of the battery abut the left wall of the tray; and
wherein the batteries are received in the tray such that, for each battery that is adjacent the right wall of the tray, the first and second left feet and the first and second left standoffs of the battery abuts the right wall of the tray.

19. The system of claim 16 wherein:
the batteries are received in the tray with the front wall of each battery facing outward of the tray;
each battery comprises a belt loop member on a central portion of the front wall and defining a channel that is configured to receive a belt for lowering the battery into the tray and/or lifting the battery into the tray.

20. A method comprising:
providing a battery comprising a case and first and second terminals, each terminal comprising a bushing over-molded into the case and a busbar extending upwardly from the bushing; and
for each terminal, plasma welding the busbar of the terminal including melting a top portion of the busbar such that the busbar is fused to a bussing that is connected to plate tabs of the battery.

21-36. (canceled)
